(19) United States
(12) Patent Application Publication
(10) Pub. No.: US 2022/0234319 A1
(43) Pub. Date: Jul. 28, 2022

(54) METHOD FOR PRODUCING A WIND TURBINE BLADE

(71) Applicants: BLADE DYNAMICS LIMITED, Eastleigh Hampshire (GB); LM WIND POWER A/S, Kolding (DK)

(72) Inventors: Sigmund WENNINGSTED, Kolding (DK); Jeppe WENDELBOE, Kolding (DK); Manish MUKHERJEE, Eastleigh Hampshire (GB); Laszlo BARTHA, Kolding (DK); Adlakadi RAJU, Kolding (DK)

(21) Appl. No.: 17/617,848

(22) PCT Filed: Jun. 12, 2020
(86) PCT No.: PCT/EP2020/066377

§ 371 Date: Dec. 9, 2021

(30) Foreign Application Priority Data
Jun. 17, 2019 (GB) 1908641.2

(51) Int. Cl. B29D 99/00; B29C 65/48; B29C 65/78

(52) U.S. Cl. CPC B29D 99/0028; B29L 2031/085; B29C 65/7826; B29C 65/483

(57) ABSTRACT

Disclosed is a method for assembling a wind turbine blade comprising a first blade component, e.g. a first blade half shell, and a second blade component, e.g. a second blade half shell, the first blade component comprising a first contact area configured to be connected to a second contact area of the second blade component, the first contact area having a first contact surface, the second contact area having a second contact surface.

The present disclosure relates to wind turbine blades and manufacture of wind turbine blades. More specifically, the present disclosure pertains to the field of joining of parts of a wind turbine blade, such as joining of interfaces, such as a leading edge glue line or a trailing edge glue line, or part thereof. In particular, the present disclosure is related to joining of a trailing edge joint of a flatback wind turbine blade.

### BACKGROUND

Wind turbine blades of fibre-reinforced polymer and in particular the aerodynamic shells of wind turbine blades are usually manufactured in moulds, where the pressure side and the suction side of the blade are manufactured separately by arranging glass fibre mats and/or other fibre-reinforcement material, such as carbon fibre, in each of the two moulds. Afterwards, one of the two halves is turned upside down and positioned on top of the other of the two halves, and the two halves are adhered together. The blade parts may be positioned on top of each other by turning and repositioning the complete half mould.

A wind turbine blade may be manufactured by infusing fibres, such as glass fibre mats and/or carbon fibre mats with a resin, such as polyester or epoxy. Infusion of the fibres may be provided by vacuum assisted resin transfer moulding (VARTM).

As wind turbines and wind turbine blades increase in size, the blade loads, i.e. strains, bending moments, peel loads etc., in particular along the trailing edge, increase. For this and other reasons, the design of the trailing edge is an important factor for the efficiency of the wind turbine. Wind turbine blades comprising a flatback profile at the trailing edge may have an increased efficiency. An optimized profile comprises a varying geometry of the trailing edge along the airfoil region of the blade.

However, it may be complicated to assemble a wind turbine blade with a flatback trailing edge. In particular, it may be challenging to sufficiently bond together trailing edge interfaces between the pressure side and suction side blade shell when the blade comprises a flatback profile.

### SUMMARY OF THE INVENTION

It is an object of the present disclosure to provide a wind turbine blade and a method for manufacturing a wind turbine blade, which overcomes at least some of the disadvantages of the prior art.

In particular, it is an object of the present invention to provide a wind turbine blade and a method for manufacturing a wind turbine blade, which enhance mechanical properties as well as manufacturing convenience of bonding between blade parts, such as a suction side blade half shell and an pressure side blade half shell, in particular throughout the trailing edge of a wind turbine blade with a flatback profile. However, the present disclosure may equally be applied to bonding of other blade components which could benefit from the application of a glue flange, as disclosed.

Thus, the present disclosure relates to a method for assembling a wind turbine blade, such as a wind turbine blade comprising a first blade component, e.g. a first blade half shell, and a second blade component, e.g. a second blade half shell.

The first blade component comprises a first contact area configured to be connected to a second contact area of the second blade component, e.g. to form a leading edge and/or a trailing edge, such as a flatback trailing edge, of the wind turbine blade. The first contact area has a first contact surface. The second contact area has a second contact surface. The first contact area may comprise a first contact edge of the first blade component. The second contact area may comprise a second contact edge of the second blade component. The first contact edge and the second contact edge may be configured to be adjacently arranged during assembly of the wind turbine blade, e.g. to form a bond line of the wind turbine blade, e.g. along the leading edge and/or the trailing edge of the wind turbine blade. The first blade component may be a suction side half shell of the wind turbine blade or a pressure side half shell of the wind turbine blade. The second blade component may be the opposite blade half shell, such as the pressure side half shell of the wind turbine blade or the suction side half shell of the wind turbine blade.

The method comprises providing a flange element having a first flange surface configured to face the first contact surface and a second flange surface configured to face the second contact surface. The flange element comprises a flexible part along the first flange surface allowing a first primary flange surface of the first flange surface to be angled relative to a first secondary flange surface of the first flange surface. The first flange surface may join the second flange surface e.g. along a flange surface interface.

The method further comprises positioning the flange element against the first blade component and/or the first contact surface, such that the first flange surface is facing the first contact surface.

The flange element may be positioned such that the first primary flange surface is closer to the first contact edge than the first secondary flange surface.

The method further comprises: bonding the first secondary flange surface to the first contact surface with a first adhesive substance; pivoting the first primary flange surface to open the cavity between the first flange surface and the first contact surface; bonding the first primary flange surface to the first contact surface with a second adhesive substance, wherein the second adhesive substance and the first adhesive substance are different types of adhesive substances; and bonding the second contact surface of the second blade component to the second flange surface.

The present disclosure may facilitate more accurate placement of adhesive flanges as well as other features influential to the blade design and manufacturing tolerances, thereby stronger wind turbine blades may be provided, production time may be reduced, and/or necessity of service and repair of the wind turbine blade may be reduced.

Although the present disclosure is focused towards the assembly of a flatback trailing edge, i.e. the joining of a suction side half shell and a pressure side half shell at the trailing edge, it is emphasized that the principles as described herein may be applied alternatively or additionally to joining of other components of a wind turbine blade.

The present disclosure is specifically advantageous, when the first contact surface and the second contact surface in the assembled wind turbine blade is not parallel, e.g. wherein the first contact surface and the second contact surface forms an angle, such as an angle more than 10 degrees, such as more than 30 degrees, such as more than 45 degrees, such as more than 60 degrees. In such situations, it may be difficult to sufficiently bond, e.g. with an adhesive substance, such as a glue, the first contact surface and the second contact surface. The present disclosure facilitates sufficient bonding between the first blade component and the second blade component, in these situations.

The first adhesive substance may be of a first type of adhesive substance, such as a fast curing glue. The first adhesive substance may have a first curing time. The first curing time may be less than 300 seconds, such as less than 180 seconds, such as less than 120 seconds, such as less than 60 seconds. The first type of adhesive substance may be incompliant with required mechanical properties for joining of the first blade component and the second blade component. The first adhesive substance may be a tacky tape.

The second adhesive substance may be of a second type of adhesive substance. The second type of adhesive substance may be different than the first type of adhesive substance. The second adhesive substance may have a second curing time. The second curing time may be more than 120 seconds, such as more than 180 seconds, such as more than 300 seconds, such as more than 600 seconds. The second curing time may be longer than the first curing time. The second type of adhesive substance may be compliant with required mechanical properties for joining of the first blade component and the second blade component.

Bonding of the first secondary flange surface to the first contact surface may comprise applying the first adhesive substance between the first secondary flange surface and the first contact surface. Bonding the first secondary flange surface to the first contact surface may comprise, e.g. after applying the first adhesive substance between the first secondary flange surface and the first contact surface, applying a first pressure to the flange element to press the first secondary flange surface against the first contact surface. Bonding the first secondary flange surface to the first contact surface may comprise curing the first adhesive substance while applying the first pressure. Bonding the first secondary flange surface to the first contact surface may comprise, e.g. after the first adhesive substance has been cured, releasing the first pressure.

Bonding the first primary flange surface to the first contact surface may comprise applying the second adhesive substance between the first primary flange surface and the first contact surface. Bonding the first primary flange surface to the first contact surface may comprise, e.g. after applying the second adhesive substance between the first primary flange surface and the first contact surface, applying a second pressure to the flange element to press the first primary flange surface against the first contact surface. Bonding the first primary flange surface to the first contact surface may comprise curing the second adhesive substance while applying the second pressure. Bonding the first primary flange surface to the first contact surface may comprise, e.g. after the second adhesive substance has been cured, releasing the second pressure.

Bonding the second contact surface to the second flange surface may comprise applying a third adhesive substance onto the second flange surface. Bonding the second contact surface to the second flange surface may comprise, e.g. after applying the third adhesive substance onto the second flange surface, positioning the second blade component such that the second contact surface is positioned against the third adhesive substance and the second flange surface. Bonding the second contact surface to the second flange surface may comprise curing the third adhesive substance. Bonding the second contact surface to the second flange surface may comprise positioning the second blade component such that the second contact edge is arranged adjacently the first contact edge, e.g. to form a bond line, e.g. along the leading edge and/or the trailing edge of the wind turbine blade.

The third adhesive substance may be of a third type of adhesive substance. The third adhesive substance may have a third curing time. The third curing time may be more than 120 seconds, such as more than 180 seconds, such as more than 300 seconds, such as more than 600 seconds. The third curing time may be longer than the first curing time. The third type of adhesive substance may be compliant with required mechanical properties for joining of the first blade component and the second blade component. The third adhesive substance and the second adhesive substance may be the same type of adhesive substance, such as the second adhesive substance. For example, the third adhesive substance may be the second type of adhesive substance.

After bonding the first flange surface, e.g. the first primary flange surface and/or the first secondary flange surface, to the first contact surface and bonding the second flange surface with the second contact surface, the first flange surface, e.g. the first primary flange surface and/or the first secondary flange surface, the second flange surface and/or the flange surface interface may be covered, such as completely covered, by adhesive substance, e.g. including the first adhesive substance, the second adhesive substance and/or the third adhesive substance.

The method may comprise, e.g. prior to bonding the first secondary flange surface to the first contact surface and/or prior to positioning the flange element against the first blade component, positioning a barrier element to maintain the first adhesive substance between the first secondary flange surface and the first contact surface. The barrier element may be coupled to the flange element. The barrier element may be positioned onto the first contact surface. The barrier element may be fastened to the first contact surface, e.g. by tacky tape, or by an adhesive, such as an adhesive similar to the first adhesive substance. The barrier element may be a foam element, such as a foam strip. The barrier element may be positioned more distant from the first contact edge than the flange element, e.g. the barrier element may be positioned such as to allow the flange element to be positioned between the barrier element and the first contact edge.

The method may comprise, e.g. prior to bonding the first primary flange surface to the first contact surface and/or prior to bonding the first secondary flange surface to the first contact surface and/or prior to positioning the flange element against the first blade component, positioning a spacer between the first contact surface and the first primary flange surface to maintain a controlled distance between the first contact surface and the first primary flange surface. The spacer may be fastened to the first contact surface, e.g. by tacky tape, or by an adhesive, such as an adhesive similar to the first adhesive substance. The spacer may comprise a plurality of spacer elements, such as cylindrical elements, e.g. having a diameter between 5 and 15 mm, such as approximately 10 mm. The spacer may have a height between 5 and 15 mm, such as approximately 11 mm. The spacer may have a height lower than a height of the barrier element, such as 50% of the height of the barrier element.

It is envisaged that any embodiments or elements as described in connection with any one aspect may be used with any other aspects or embodiments, mutatis mutandis.

### BRIEF DESCRIPTION OF THE FIGURES

Embodiments of the invention will be described in more detail in the following with regard to the accompanying figures. Like reference numerals refer to like elements throughout. Like elements may, thus, not be described in detail with respect to the description of each figure. The figures show one way of implementing the present invention and are not to be construed as being limiting to other possible embodiments falling within the scope of the attached claim set. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

FIG. 1 is a schematic diagram illustrating an exemplary wind turbine,

FIG. 2 is a schematic diagram illustrating an exemplary wind turbine blade,

FIG. 3 is a schematic diagram illustrating an exemplary wind turbine blade,

FIG. 4 is a schematic diagram illustrating a cross section of an exemplary wind turbine blade,

FIGS. 5-12 illustrates exemplary instances of an exemplary method for assembling a wind turbine blade,

FIGS. 13a-k show parts of cross sections a wind turbine blade at various positions, and

FIG. 14 is a block diagram of an exemplary method.

### DETAILED DESCRIPTION

In the following figure description, the same reference numbers refer to the same elements and may thus not be described in relation to all figures.

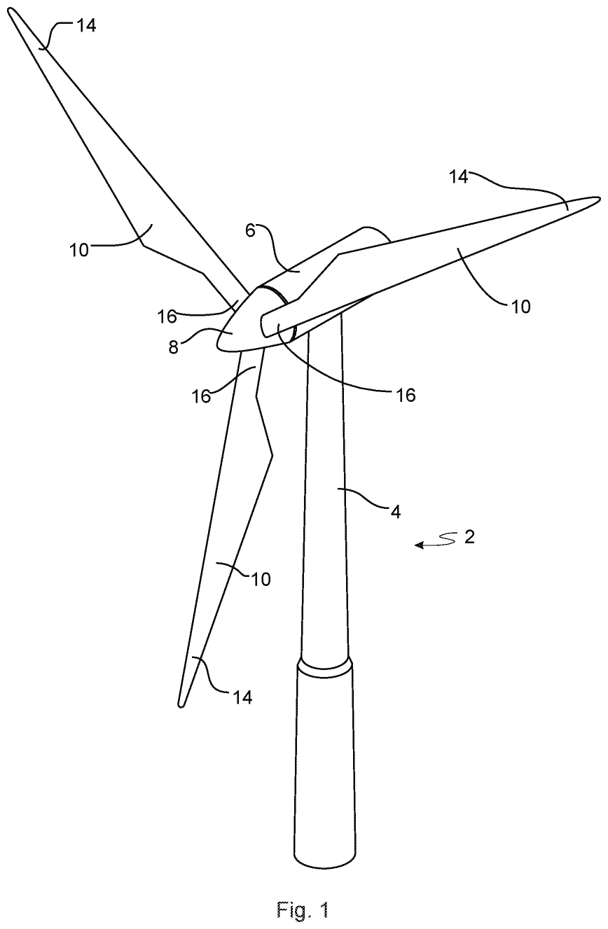

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

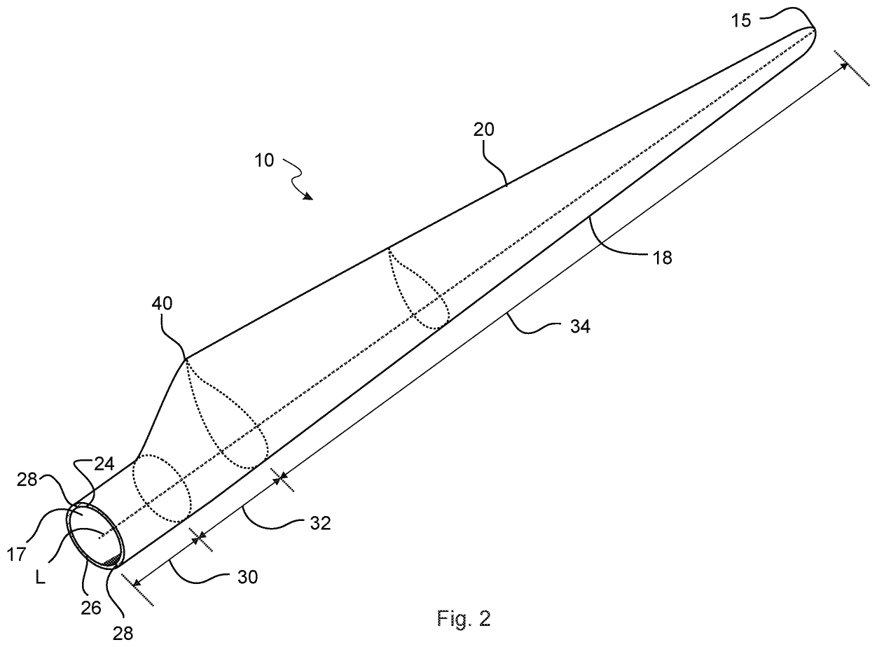

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The wind turbine blade 10 comprises a blade shell comprising two blade shell parts or half shells, a first blade shell part 24 and a second blade shell part 26, typically made of fibre-reinforced polymer. The wind turbine blade 10 may comprise additional shell parts, such as a third shell part and/or a fourth shell part. The first blade shell part 24 is typically a pressure side or upwind blade shell part. The second blade shell part 26 is typically a suction side or downwind blade shell part.

The first blade shell part 24 and the second blade shell part 26 are fastened together with adhesive, such as glue, along bond lines or glue joints 28 extending along the trailing edge 20 and the leading edge 18 of the blade 10. Typically, the root ends of the blade shell parts 24, 26 has a semi-circular or semi-oval outer cross-sectional shape.

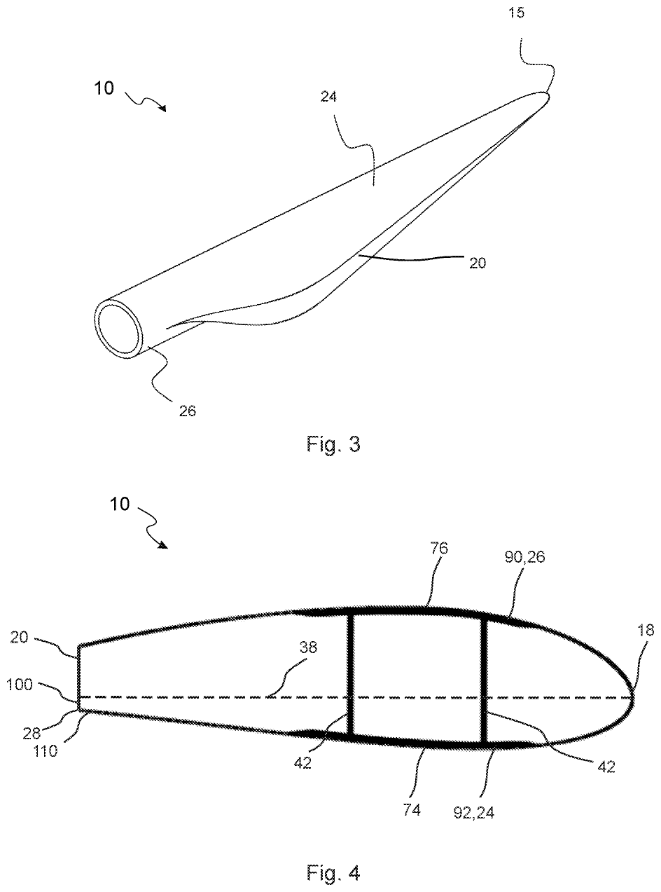

FIG. 3 shows a wind turbine blade 10 with a flatback profile at the trailing edge 20. The trailing edge 20 has a flattened profile. The flattened profile may increase the aerodynamic efficiency and also may reduce the chord width, thereby making it easier to transport the wind turbine blade 10. Furthermore, it also may reduce required manufacturing space.

FIG. 4 is a schematic diagram illustrating a cross sectional view of an exemplary wind turbine blade 10, e.g. a cross sectional view of the airfoil region of the wind turbine blade 10 as described in relation to FIG. 3. The wind turbine blade 10 comprises a leading edge 18, a trailing edge 20, a pressure side 24, a suction side 26 a first spar cap 74, and a second spar cap 76. The trailing edge 20 has a flattened profile for forming a flatback profile. The wind turbine blade 10 comprises a chord line 38 between the leading edge 18 and the trailing edge 20. The wind turbine blade 10 comprises shear webs 42, such as a leading edge shear web and a trailing edge shear web. The shear webs 42 could alternatively be a spar box with spar sides, such as a trailing edge spar side and a leading edge spar side. The spar caps 74, 76 may comprise carbon fibres, e.g. in combination with glass fibres, while the rest of the shell parts 24, 26 may comprise glass fibres.

The wind turbine blade 10, such as the shell parts 24, 26 may comprise sandwich panels, e.g. comprising lightweight materials such as balsa or foam sandwiched between fibre-reinforced layers. The trailing edge 20 forming the flattened profile may be provided as a third shell part, or as an integral part of the first shell part 24 or the second shell part 26. Alternatively, the trailing edge 20 may be provided by parts of both the first shell part 24 and the second shell part 26.

A glue joint for assembling the first shell part 24 and the second shell part 26 may be provided near the trailing edge 20, such as between a first trailing edge part of the trailing edge 20 and a second trailing edge part of the trailing edge 20. Alternatively, the glue joint may be provided between the trailing edge 20 and the first shell part 24 or between the trailing edge 20 and the second shell part 26.

In the example described with respect to the following figures, a glue joint or bond line 28 between the trailing edge 20 (forming part of the second shell part 26) and the first shell part 24 is described. The second shell part 26 constitutes a first blade component 90 and the first shell part 24 including the trailing edge 20 constitutes a second blade component 92. The first blade component 90 comprises a first contact area 100 configured to be connected to a second contact area 110 of the second blade component 92. The first contact area 100 may form part of the trailing edge 20. In an alternative, non-illustrated, example, the second contact area 110 forms part of the trailing edge 20.

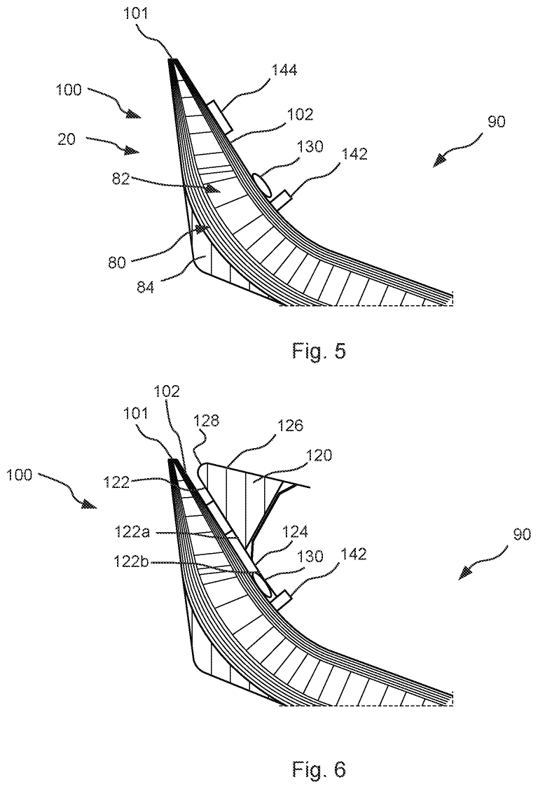

FIGS. 5-12 illustrates exemplary instances of a method for assembling a wind turbine blade, such as the wind turbine blade 10, e.g. of FIG. 3, comprising a first blade component 90, such as the first shell part 24 or the second shell part 26, and a second blade component, such as the other shell part, e.g. the first shell part 24 or the second shell part. The first blade component 90 comprises a first contact area 100 configured to be connected to a second contact area 110 of the second blade component 92. Although the illustrated examples are described with reference to the first blade component and the second blade component being respective shell parts, it will be understood that the method may be utilized similarly in assembling other blade components.

The first contact area 100 has a first contact surface 102. The second contact area 110 has a second contact surface 112. The first contact area 100 comprises a first contact edge 101 of the first blade component 90. The second contact area 110 comprises a second contact edge 111 of the second blade component 92. The present disclosure is specifically advantageous, when the first contact surface 102 and the second contact surface 112 in the assembled wind turbine blade is not parallel, such as will be the case when assembling the shell parts of a flatback wind turbine blade near the trailing edge.

FIG. 5 illustrates a first blade component 90 comprising a first contact area 100 configured to be connected to a second contact area of a second blade component. The first contact area 100 has a first contact surface 102. The first contact area 100 comprises a first contact edge 101.

Also illustrated is that the first blade component 90, e.g. being a first shell part or a second shell part, comprises sandwich structure. For example, the first blade component 90 comprises a shell core 82, e.g. of balsa wood or foam, and an inner and outer fibre reinforced layer 80. Also illustrated is an insert 84 provided between the trailing edge part 20 and the remaining shell part of the first blade component 90. The insert 84 is provided to give the flatback profile of the trailing edge a relatively sharp corner.

A first adhesive substance 130 is applied to the first contact surface 102. A barrier element 142 is positioned to maintain the first adhesive substance 130 at the applied position, e.g. to prevent the first adhesive substance 130 to flow by act of gravity along the first contact surface 102 to the bottom of the blade shell. The first adhesive substance 130 is applied closer to the first contact edge 101 than the barrier element 142. In some examples, the barrier element 142 may not be needed, e.g. if the slope of the first contact surface 102 is not very steep, or if the first adhesive substance is substantially stiff, has a high viscosity, or in other ways not prone to substantial flow.

A spacer 144 is positioned onto the first contact surface to maintain a controlled distance between the first contact surface 102 and the flange element to be bonded to the first contact surface 102. The spacer 144 may facilitate that the correct amount of adhesive substance is provided between the first contact surface 102 and the flange element of the following figures, such as to attain the required mechanical properties of the bonding.

FIG. 6 illustrates the first blade component 90, wherein a flange element 120 has been provided and positioned against the first blade component 90, e.g. against the first contact surface 102.

The flange element 120 has a first flange surface 122 configured to face the first contact surface 102 and a second flange surface 126 configured to face the second contact surface of the second blade component. The first flange surface 122 joins the second flange surface 126 along a flange surface interface 128. The flange element 120 comprises a flexible part 124 along the first flange surface 122 allowing a first primary flange surface 122a of the first flange surface 122 to be angled relative to a first secondary flange surface 122b of the first flange surface 122. The flexible part 124 may be a hinge element or may be a relatively thin part of material allowing the angling between the first primary flange surface 122a and the first secondary flange surface 122b.

The first adhesive substance 130 is applied between the first secondary flange surface 122b and the first contact surface 102. The first adhesive substance 130 may be applied between the first secondary flange surface 122b and the first contact surface 102 after the flange element 120 is positioned or be applied prior to positioning the flange element 120 as exemplified by FIG. 5.

The flange element 120 is positioned such that the first primary flange surface 122a is closer to the first contact edge 101 than the first secondary flange surface 122b.

The barrier element 142 may be provided as a part of the flange element 120 or, as exemplified by FIG. 5, be positioned onto the first contact surface 102 prior to positioning the flange element 120.

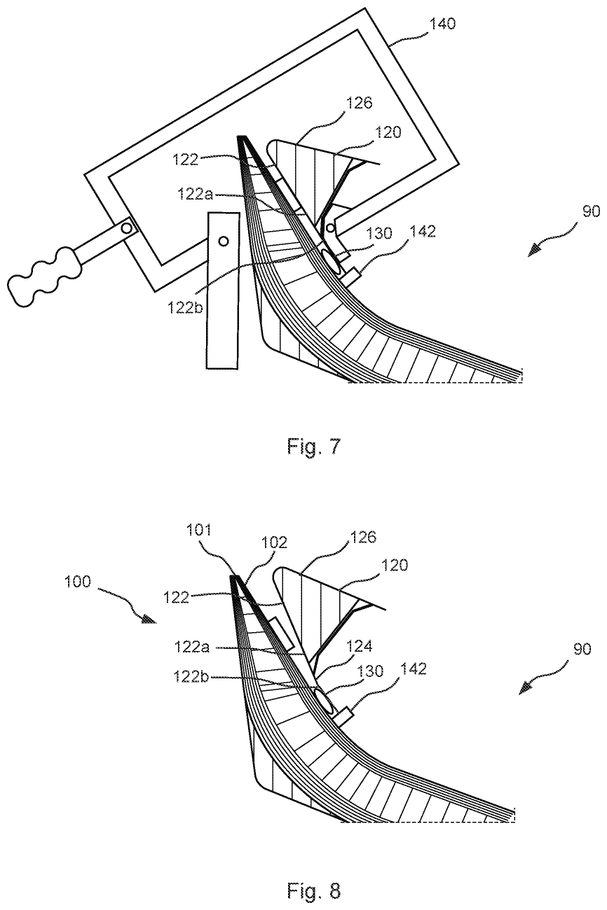

FIG. 7 illustrates the first blade component 90, wherein a first pressure is applied to the flange element 120 to press the first secondary flange surface 122b against the first contact surface 102. In the illustrated example, the first pressure is applied by a clamp 140. The first pressure may be applied while curing the first adhesive substance 130, which may be a fast curing type of adhesive. After the first adhesive substance 130 is cured, bonding the first secondary flange surface 122b and the first contact surface 102, the pressure may be released.

FIG. 8 illustrates the first blade component 90, wherein the first primary flange surface 122a is pivoted relative to the first secondary flange surface 122b about the flexible part 124 to open the cavity between the first flange surface 122, in particular the first primary flange surface 122a, and the first contact surface 102.

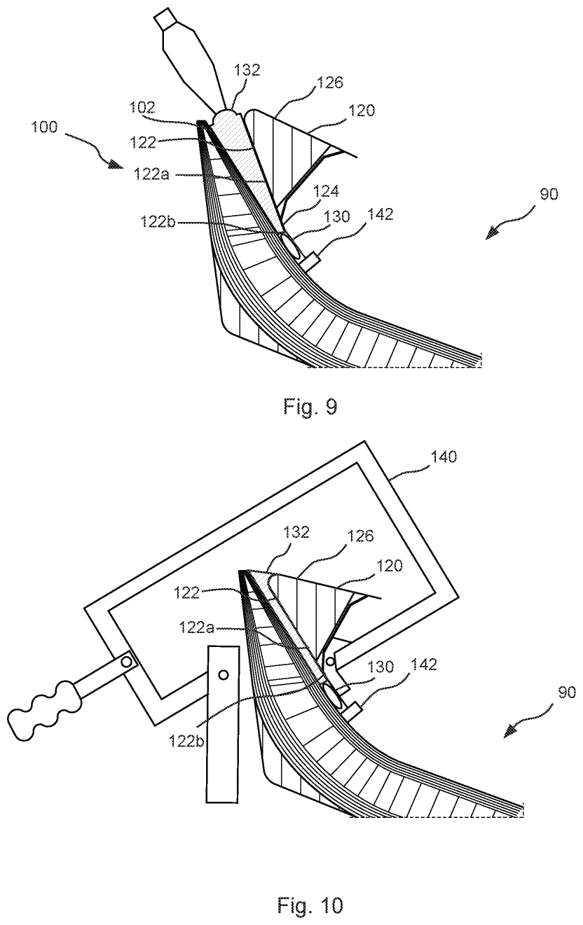

FIG. 9 illustrates the first blade component 90, wherein a second adhesive substance 132 is applied between the first primary flange surface 122a and the first contact surface 102, while the flange element 120 is pivoted to open the cavity between the first flange surface 122 and the first contact surface 102. Thereby it may be ensured, e.g. by visual inspection, that the cavity is sufficiently filled with the second adhesive substance 132. The bonding between the first secondary flange surface 122b and the first contact surface 102 ensures that the position of the flange element 120 is not changed during this process.

FIG. 10 illustrates the first blade component 90, wherein a second pressure is applied to the flange element 120 to press the first primary flange surface 122a against the first contact surface 102. In the illustrated example, the second pressure is applied by a clamp 140, e.g. the same clamp 140 as used to apply the first pressure as described with respect to FIG. 7. The second pressure may be applied while curing the second adhesive substance 132. After the second adhesive substance 132 is cured, bonding the first primary flange surface 122a and the first contact surface 102, the pressure may be released. Thereby, the first primary flange surface 122a may be bonded to the first contact surface 102 with the second adhesive substance 132. The second adhesive substance 132 may be a different type of adhesive substance than the first adhesive substance 130. For example, the second adhesive substance may comply with structural requirements for the joining between the first blade component and the second blade component. The second adhesive substance 132 may have a longer curing time than the first adhesive substance 130.

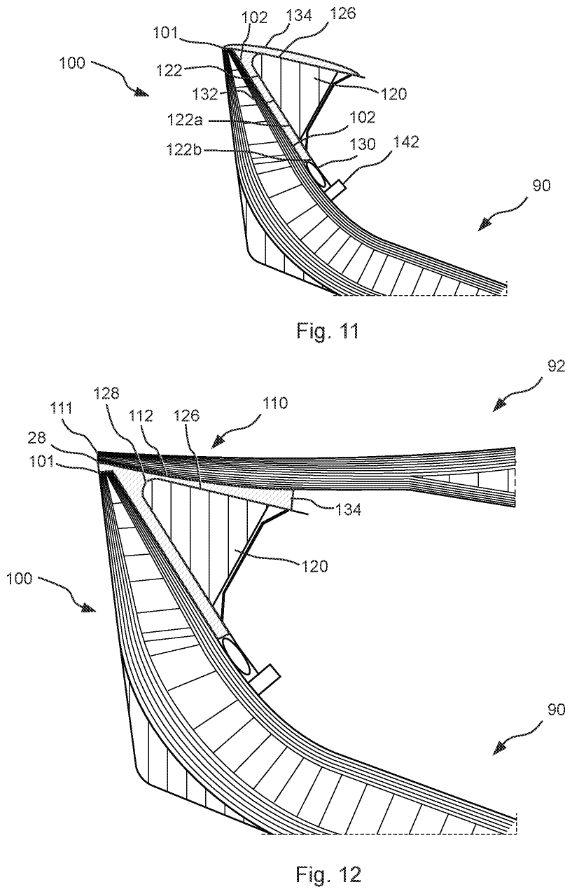

FIG. 11 illustrates the first blade component 90, wherein a third adhesive substance 134 is applied onto the second flange surface 126. The third adhesive substance 134 may be the same type of adhesive substance as the second adhesive substance 132.

FIG. 12 illustrates the first blade component 90, wherein the second blade component 92 is positioned in its desired position relative to the first blade component 90. The second blade component comprises a second contact area 110 configured to be connected to the first contact area 100 of the first blade component 90. The second contact area 110 has a second contact surface 112. The second contact area 110 comprises a second contact edge 111.

The second blade component 92 is positioned such that the second contact surface 112 is positioned against the third adhesive substance 134 and the second flange surface 126. The second blade component 92 is positioned such that the second contact edge 111 is arranged adjacently the first contact edge 101, to form the bond line 28. The first adhesive substance 134 is cured. Pressure may be applied while curing the third adhesive substance 134. However, the weight of the second blade component 92 may provide sufficient pressure.

Thereby, the second contact surface 112 of the second blade component 92 may be bonded to the second flange surface 126 as well as to the first blade component 90. The first flange surface 122, e.g. including the first primary flange surface 122a and the first secondary flange surface 122b, the second flange surface 126 and the flange surface interface 128 may be covered by the adhesive substance, e.g. including the first adhesive substance 130, the second adhesive substance 132 and/or the third adhesive substance 134.

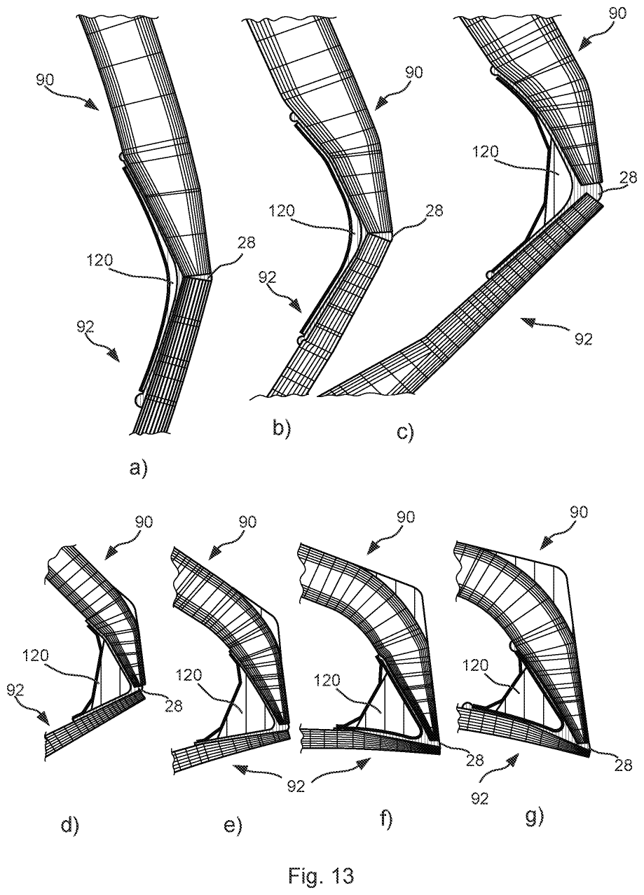

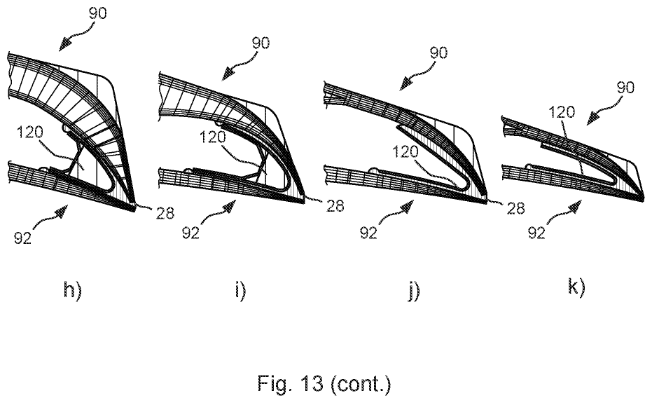

FIGS. 13a-k show parts of cross sections a wind turbine blade at various positions along the length of the blade. In particular, it is seen how the shape of the flange element 120 may vary along the length of the wind turbine blade to accommodate the different angles of the joining blade components 90, 92.

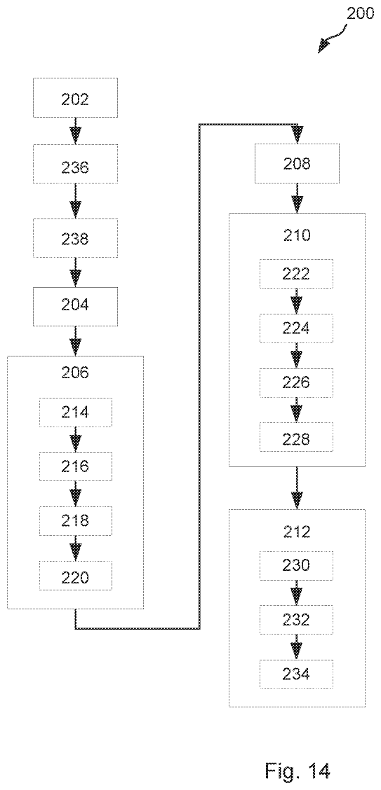

FIG. 14 is a block diagram of an exemplary method 200 for assembling a wind turbine blade comprising a first blade component, e.g. a first blade half shell, and a second blade component, e.g. a second blade half shell.

The method 200 comprises providing 202 a flange element. The provided 202 flange element has a first flange surface configured to face a first contact surface of a first contact area of the first blade component. The provided 202 flange element has a second flange surface configured to face a second contact surface of a second contact area of the second blade component.

The method 200 comprises positioning 204 the flange element against the first blade component, such that the first flange surface is facing the first contact surface; and bonding 206 a first secondary flange surface of the first flange surface to the first contact surface with a first adhesive substance. The flange element may be positioned 204 such that the first primary flange surface is closer to a first contact edge of the first blade component than the first secondary flange surface.

The flange element comprises a flexible part along the first flange surface allowing a first primary flange surface of the first flange surface to be angled relative to the first secondary flange surface. The method 200 comprises, e.g. after having bonded 206 the first secondary flange surface to the first contact surface, pivoting 208 the first primary flange surface to open the cavity between the first flange surface and the first contact surface, and bonding 210 the first primary flange surface to the first contact surface with a second adhesive substance, wherein the second adhesive substance and the first adhesive substance are different types of adhesive substances.

The method 200 comprises, e.g. after having bonded 210 the first primary flange surface to the first contact surface, bonding 212 the second contact surface of the second blade component to the second flange surface.

The method 200 may optionally comprise, e.g. prior to positioning 204 the flange element and/or prior to bonding 206 the first secondary flange surface to the first contact surface, positioning 236 a barrier element, e.g. to maintain the first adhesive substance between the first secondary flange surface and the first contact surface.

The method 200 may optionally comprise, e.g. prior to positioning 204 the flange element and/or prior to bonding 206 the first secondary flange surface to the first contact surface and/or prior to bonding 210 the first primary flange surface to the first contact surface, positioning 238 a spacer between the first contact surface and the first primary flange surface, e.g. to maintain a controlled distance between the first contact surface and the first primary flange surface.

Bonding 206 the first secondary flange surface to the first contact surface may comprise applying 214 the first adhesive substance between the first secondary flange surface and the first contact surface. Bonding 206 the first secondary flange surface to the first contact surface may comprise applying 216 a first pressure to the flange element to press the first secondary flange surface against the first contact surface. Bonding 206 the first secondary flange surface to the first contact surface may comprise curing 218 the first adhesive substance, e.g. while applying 216 the first pressure. Bonding 206 the first secondary flange surface to the first contact surface may comprise releasing 220 the first pressure.

Bonding 210 the first primary flange surface to the first contact surface may comprise applying 222 the second adhesive substance between the first primary flange surface and the first contact surface. Bonding 210 the first primary flange surface to the first contact surface may comprise applying 224 a second pressure to the flange element to press the first primary flange surface against the first contact surface. Bonding 210 the first primary flange surface to the first contact surface may comprise curing 226 the second adhesive substance, e.g. while applying 224 the second pressure. Bonding 210 the first primary flange surface to the first contact surface may comprise releasing 228 the second pressure.

Bonding 212 the second contact surface to the second flange surface may comprise applying 230 a third adhesive substance onto the second flange surface. The third adhesive substance may be the same type of adhesive substance as the second adhesive substance. Bonding 212 the second contact surface to the second flange surface may comprise positioning 232 the second blade component such that the second contact surface is positioned against the third adhesive substance and the second flange surface. Bonding 212 the second contact surface to the second flange surface may comprise positioning the second blade component such that the second contact edge is arranged adjacently the first contact edge, e.g. to form a bond line. Bonding 212 the second contact surface to the second flange surface may comprise curing the third adhesive substance.

Exemplary embodiments of the present disclosure are set out in the following items:
1. A method for assembling a wind turbine blade comprising a first blade component, e.g. a first blade half shell, and a second blade component, e.g. a second blade half shell, the first blade component comprising a first contact area configured to be connected to a second contact area of the second blade component, the first contact area having a first contact surface, the second contact area having a second contact surface,
the method comprising:
   providing a flange element having a first flange surface configured to face the first contact surface and a second flange surface configured to face the second contact surface, the flange element comprises a flexible part along the first flange surface allowing a first primary flange surface of the first flange surface to be angled relative to a first secondary flange surface of the first flange surface;
   positioning the flange element against the first blade component such that the first flange surface is facing the first contact surface;
   bonding the first secondary flange surface to the first contact surface with a first adhesive substance;
   pivoting the first primary flange surface to open the cavity between the first flange surface and the first contact surface;
   bonding the first primary flange surface to the first contact surface with a second adhesive substance, wherein the second adhesive substance and the first adhesive substance are different types of adhesive substances; and
   bonding the second contact surface of the second blade component to the second flange surface.
2. Method according to item 1, wherein the first adhesive substance has a first curing time, and wherein the first curing time may be less than 300 seconds, such as less than 180 seconds, such as less than 120 seconds, such as less than 60 seconds.
3. Method according to any of the preceding items, wherein the second adhesive substance has a second curing time, and wherein the second curing time may be more than 120 seconds, such as more than 180 seconds, such as more than 300 seconds.
4. Method according to item 3 as dependent on item 2, wherein the second curing time is longer than the first curing time.
5. Method according to any of the preceding items, wherein bonding the first secondary flange surface to the first contact surface comprises:
   applying the first adhesive substance between the first secondary flange surface and the first contact surface
6. Method according to the preceding item, wherein bonding the first secondary flange surface to the first contact surface comprises:
   applying a first pressure to the flange element to press the first secondary flange surface against the first contact surface;
   curing the first adhesive substance while applying the first pressure;
   releasing the first pressure;
7. Method according to any of the preceding items, wherein bonding the first primary flange surface to the first contact surface comprises:
   applying the second adhesive substance between the first primary flange surface and the first contact surface;
8. Method according to the preceding item, wherein bonding the first primary flange surface to the first contact surface comprises:
   applying a second pressure to the flange element to press the first primary flange surface against the first contact surface;
   curing the second adhesive substance while applying the second pressure;
   releasing the second pressure;
9. Method according to any of the preceding items, wherein bonding the second contact surface to the second flange surface:
   applying a third adhesive substance onto the second flange surface;
   positioning the second blade component such that the second contact surface is positioned against the third adhesive substance and the second flange surface;
   curing the third adhesive substance.
10. Method according to any of the preceding items further comprising, prior to bonding the first secondary flange surface to the first contact surface, positioning a barrier element to maintain the first adhesive substance between the first secondary flange surface and the first contact surface.
11. Method according to any of the preceding items further comprising, prior to bonding the first primary flange surface to the first contact surface, positioning a spacer between the first contact surface and the first primary flange surface to maintain a controlled distance between the first contact surface and the first primary flange surface.

The invention has been described with reference to preferred embodiments. However, the scope of the invention is not limited to the illustrated embodiments, and alterations and modifications can be carried out without deviating from the scope of the invention.

### LIST OF REFERENCES

2 wind turbine
4 tower
6 nacelle
8 hub
10 blade
14 blade tip
15 tip end
16 blade root
17 root end
18 leading edge
20 trailing edge
24 first blade shell part (pressure side)
26 second blade shell part (suction side)
28 bond lines/glue joints
30 root region
32 transition region
34 airfoil region
40 shoulder
42 shear web or spar side
74 first spar cap
76 second spar cap
80 fibre-reinforced layer
82 shell core
84 insert
90 first blade component
92 second blade component
100 first contact area
101 first contact edge
102 first contact surface
110 second contact area
111 second contact edge
112 second contact surface
120 flange element
122 first flange surface
122a first primary flange surface
122b first secondary flange surface
124 flexible part
126 second flange surface
128 flange surface interface
130 first adhesive substance
132 second adhesive substance
134 third adhesive substance
140 clamp
142 barrier element
144 spacer
200 method
202 providing flange element
204 positioning flange element
206 bonding first secondary flange surface and first contact surface
208 pivoting first primary flange surface
210 bonding first primary flange surface and first contact surface
212 bonding second contact surface and second flange surface
214 applying first adhesive substance
216 applying first pressure
218 curing first adhesive substance
220 releasing first pressure
222 applying second adhesive substance
224 applying second pressure
226 curing second adhesive substance
228 releasing second pressure
230 applying third adhesive substance
232 positioning second blade component
234 curing second adhesive substance
236 positioning barrier element
238 positioning spacer

1-13. (canceled)

14. A method for assembling a wind turbine blade comprising a first blade component being a first blade half shell, and a second blade component being a second blade half shell, the first blade component comprising a first contact area configured to be connected to a second contact area of the second blade component to form a leading edge and/or a trailing edge of the wind turbine blade, the first contact area having a first contact surface, the second contact area having a second contact surface, the first contact area comprises a first contact edge of the first blade component and the second contact area comprises a second contact edge of the second blade component, the first contact edge and the second contact edge being configured to be adjacently arranged to form a bond line along the leading edge and/or the trailing edge of the wind turbine blade,
the method comprising:
providing a flange element having a first flange surface configured to face the first contact surface and a second flange surface configured to face the second contact surface, the flange element comprises a flexible part along the first flange surface allowing a first primary flange surface of the first flange surface to be angled relative to a first secondary flange surface of the first flange surface;
positioning the flange element against the first blade component such that the first flange surface is facing the first contact surface, and such that the first primary flange surface is closer to the first contact edge than the first secondary flange surface;
bonding the first secondary flange surface to the first contact surface with a first adhesive substance;
pivoting the first primary flange surface to open a cavity between the first flange surface and the first contact surface;
bonding the first primary flange surface to the first contact surface with a second adhesive substance, wherein the second adhesive substance and the first adhesive substance are different types of adhesive substances; and
bonding the second contact surface of the second blade component to the second flange surface.

15. Method according to claim 14, wherein the first adhesive substance has a first curing time, and wherein the first curing time may be less than 300 seconds, such as less than 180 seconds, such as less than 120 seconds, such as less than 60 seconds.

16. Method according to claim 14, wherein the second adhesive substance has a second curing time, and wherein the second curing time may be more than 120 seconds, such as more than 180 seconds, such as more than 300 seconds.

17. Method according to claim 16, wherein the second curing time is longer than the first curing time.

18. Method according to claim 14, wherein bonding the first secondary flange surface to the first contact surface comprises:
applying the first adhesive substance between the first secondary flange surface and the first contact surface

19. Method according to claim 18, wherein bonding the first secondary flange surface to the first contact surface comprises:
applying a first pressure to the flange element to press the first secondary flange surface against the first contact surface;
curing the first adhesive substance while applying the first pressure;
releasing the first pressure;

20. Method according to claim 14, wherein bonding the first primary flange surface to the first contact surface comprises:
applying the second adhesive substance between the first primary flange surface and the first contact surface;

21. Method according to claim 20, wherein bonding the first primary flange surface to the first contact surface comprises:
applying a second pressure to the flange element to press the first primary flange surface against the first contact surface;
curing the second adhesive substance while applying the second pressure;
releasing the second pressure;

22. Method according to claim 14, wherein bonding the second contact surface to the second flange surface:
applying a third adhesive substance onto the second flange surface;
positioning the second blade component such that the second contact surface is positioned against the third adhesive substance and the second flange surface;
curing the third adhesive substance.

23. Method according to claim 14, wherein bonding the second contact surface to the second flange surface comprises positioning the second blade component such that the second contact edge is arranged adjacently the first contact edge to form a bond line along the leading edge and/or the trailing edge of the wind turbine blade.

24. Method according to claim 14 further comprising, prior to bonding the first secondary flange surface to the first contact surface, positioning a barrier element to maintain the first adhesive substance between the first secondary flange surface and the first contact surface.

25. Method according to claim 24, wherein the barrier element is positioned more distant from the first contact edge than the flange element.

26. Method according to claim 14 further comprising, prior to bonding the first primary flange surface to the first contact surface, positioning a spacer between the first contact surface and the first primary flange surface to maintain a controlled distance between the first contact surface and the first primary flange surface.

27. A wind turbine blade assembled according to the method of claim 14.
